(19) United States
(12) Patent Application Publication
(10) Pub. No.: US 2019/0143374 A1
(43) Pub. Date: May 16, 2019

(54) Chip Sorting and Packaging Platform

(71) Applicants: Tyco Electronics (Shanghai) Co. Ltd., Shanghai (CN); TE Connectivity Corporation, Berwyn, PA (US); Shenzhen AMI Technology Co., Ltd., Shenzhen (CN)

(72) Inventors: Lei Zhou, Shanghai (CN); Dandan Zhang, Shanghai (CN); Roberto Francisco-Yi Lu, Berwyn, PA (US); Qinglong Zeng, Shenzhen (CN)

(73) Assignees: Tyco Electronics (Shanghai) Co. Ltd., Shanghai (CN); TE Connectivity Corporation, Berwyn, PA (US); Shenzhen AMI Technology Co., Ltd., Shenzhen (CN)

(21) Appl. No.: 16/243,559

(22) Filed: Jan. 9, 2019

Related U.S. Application Data
(63) Continuation of application No. PCT/IB2017/054192, filed on Jul. 12, 2017.

(30) Foreign Application Priority Data
Jul. 12, 2016 (CN) 201610544204.0

(51) Int. Cl. B07C 5/342; B07C 5/344; B07C 5/36; B65B 57/10; B65B 35/24; B65B 35/18

(52) U.S. Cl. CPC B07C 5/3422; B07C 5/344; B65B 35/18; B65B 57/10; B65B 35/24; B07C 5/36

(57) ABSTRACT

A chip sorting and packaging platform comprises a supply module, a sorting module, and a packaging module. The supply module is adapted to feed a plurality of chips. The sorting module is configured to pick up the chips fed by the supply module and to determine whether each of the chips is qualified. The packaging module is configured to package qualified chips of the chips sorted by the sorting module.

### CROSS-REFERENCE TO RELATED APPLICATIONS

This application is a continuation of PCT International Application No. PCT/IB2017/054192, filed on Jul. 12, 2017, which claims priority under 35 U.S.C. § 119 to Chinese Patent Application No. 201610544204.0, filed on Jul. 12, 2016.

### FIELD OF THE INVENTION

The present invention relates to electronic chips and, more particularly, to a platform for sorting and packaging chips.

### BACKGROUND

Electronic chips are widely used in the electronics industry. A low resistance (Lowrho) chip, for example, is usually small and has an irregular structure. Chips are typically sorted and packaged manually, and there is no known platform that can automatically implement the sorting and packaging of electronic chips. Manual sorting and packaging of the chips is subject to errors, as an unqualified chip may easily be determined as a qualified chip or vice versa during sorting, which results in reduced accuracy and reliability of sorting the chips. Furthermore, the efficiency of manually sorting and packaging of the chips is quite low.

### SUMMARY

A chip sorting and packaging platform comprises a supply module, a sorting module, and a packaging module. The supply module is adapted to feed a plurality of chips. The sorting module is configured to pick up the chips fed by the supply module and to determine whether each of the chips is qualified. The packaging module is configured to package qualified chips of the chips sorted by the sorting module.

### BRIEF DESCRIPTION OF THE DRAWINGS

The invention will now be described by way of example with reference to the accompanying Figures, of which:

FIG. 1 is a perspective view of a chip sorting and packaging platform according to an embodiment; and

FIG. 2 is a perspective view of a supply module, a sorting module, and a packaging module of the chip sorting and packaging platform.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will convey the concept of the disclosure to those skilled in the art.

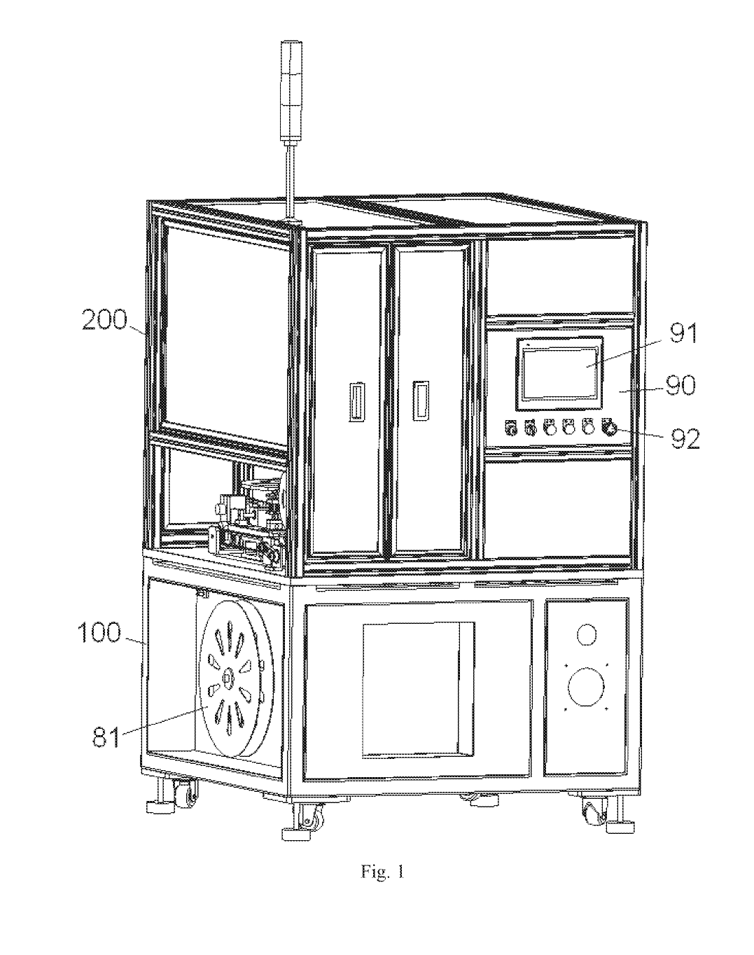

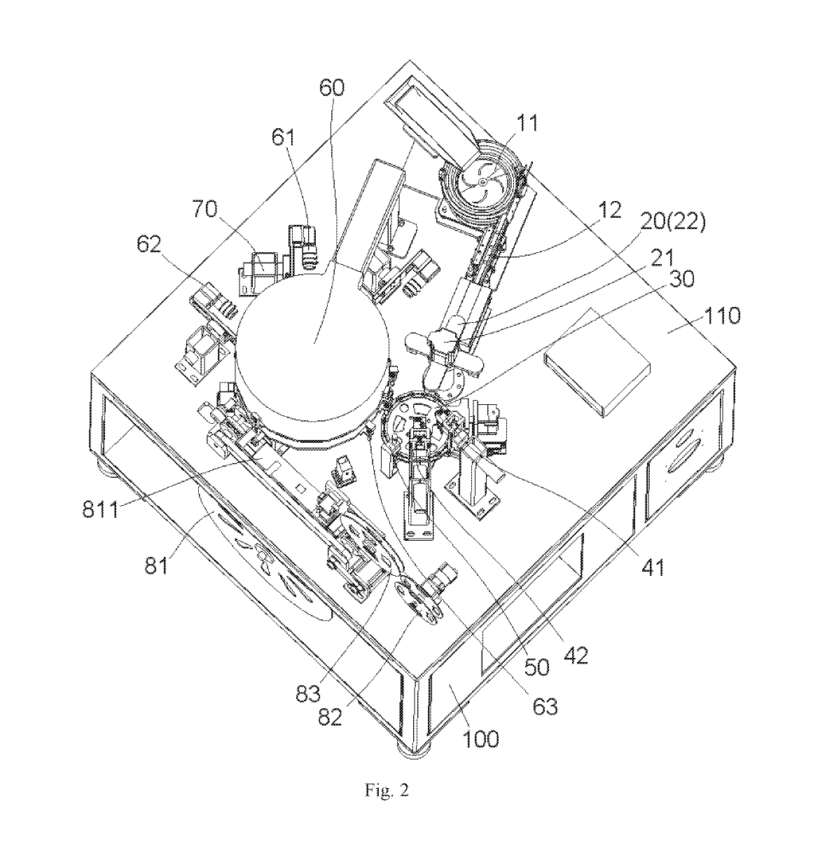

A chip sorting and packaging platform according to an embodiment is shown in FIG. 1. The chip sorting and packaging platform comprises a supply module, a sorting module, and a packaging module. The supply module is adapted to feed a plurality of chips to the sorting module. The sorting module is configured to pick up the chips fed by the supply module and detect the picked chips to determine whether the picked chips are qualified. The packaging module is configured to package the qualified chips sorted by the sorting module. The supply module, the sorting module, and the packaging module of the chip sorting and packaging platform are shown in FIG. 2.

The supply module, as shown in FIG. 2, includes a centrifugal rotary conveyor 11 and a vibratory linear conveyor 12. The centrifugal rotary conveyor 11 is adapted to centrifugally throw the chips placed therein onto the vibratory linear conveyor 12. The vibratory linear conveyor 12 is adapted to convey the chips thereon onto the sorting module in a vibrating manner.

The sorting module, as shown in FIG. 2, includes a pickup device 20, a first rotation table 30, and a first vision detector 41, 42. The pickup device 20 is adapted to pick up the chips from the vibratory linear conveyor 12 and mount the picked chips on the first rotation table 30. The first vision detector 41, 42 is adapted to detect whether each of the chips mounted on the first rotation table 30 has a defect. The sorting module includes a resistance detector 50 adapted to detect a resistance of the chips mounted on the first rotation table 30.

The first rotation table 30 has a plurality of clamps adapted to secure the chips and distributed on the first rotation table 30 at a predetermined interval around a rotation axis thereof. The pickup device 20 includes a rotation disc 21 and a plurality of suction nozzles 22 distributed around the rotation disc 21 at a predetermined interval, as shown in FIG. 2. The plurality of suction nozzles 22 suction to the chips at the vibratory linear conveyor 12 of the supply module and mount the suctioned chips on the plurality of clamps of the first rotation table 30, respectively. In the shown embodiment, the pickup device 20 has four suction nozzles 22 and the first rotation table 30 has twelve clamps.

As shown in FIG. 2, the first visual detector 41, 42 includes a first camera 41 and a second camera 42 located above the first rotation table 30 and spaced apart from each other. The first camera 41 and the second camera 42 have different light sources and are adapted to detect different defects of top portions of the chips mounted on the first rotation table 30. In an exemplary embodiment, the first camera 41 is adapted to detect defects such as a scratch and/or a dirt on the top portion of each chip mounted on the first rotation table 30. The second camera 42 is adapted to detect a solder joint defect on the top portion of each chip mounted on the first rotation table 30.

The sorting module, as shown in FIG. 2, includes a second rotation table 60 and a second visual detector 61, 62. The second rotation table 60 has a plurality of suction devices 63 on a periphery thereof at a predetermined interval. The plurality of suction devices 63 are configured to suction to the chips, which have been detected by the first vision detector 41, 42 and the resistance detector 50, at the first rotation table 30. The second vision detector 61, 62 is adapted to detect a size of each chip suctioned to the suction device 63 on the second rotation table 60 to check whether the size of each chip is qualified. In an exemplary embodiment, the second rotation table 60 has twelve suction devices 63 on a periphery thereof at the predetermined interval.

The second visual detector 61, 62, in the embodiment shown in FIG. 2, includes a third camera 61 and a fourth camera 62 located around the second rotation table 60 and spaced apart from each other. The third camera 61 and the fourth camera 62 are adapted to detect sizes of the different sides of each chip suctioned by the suction device 63 on the second rotation table 60. The optical axes of the third camera 61 and the fourth camera 62 extend in a radial direction of the second rotation table 60, i.e., the optical axes of the third camera 61 and the fourth camera 62 intersect with a rotation axis of the second rotation table 60 and are perpendicular thereto.

Once each chip is suctioned to the suction device 63 on the second rotation table 60, a first side of the chip faces outwards in the radial direction of the second rotation table 60 so as to detect the size of the first side of the chip by the third camera 61. As shown in FIG. 2, the sorting module includes a rotation mechanism 70 rotating an orientation of each chip so that a second side of the chip faces outwards in the radial direction of the second rotation table 60 so as to detect the size of the second side of the chip by the fourth camera 62 after the chip has been detected by the third camera 61.

The packaging module, as shown in FIG. 2, includes a first pulley 81, a second pulley 82, and a third pulley 83. The first pulley 81 is adapted to supply a first packaging belt 811 having a plurality of recesses into which the qualified chips which have been detected by the sorting module are received. The second pulley 82 is adapted to supply a second packaging belt for encapsulating the qualified chips in the recesses of the first packaging belt 811. The third pulley 83 is adapted to recycle the first packaging belt 811 and the second packaging belt packaged with the qualified chips. The packaging module is disposed at the periphery of the second rotation table 60, and the suction device 63 on the second rotation table 60 is adapted to directly place the detected qualified chips into the recesses of the first packaging belt 811.

In an embodiment, the chip sorting and packaging platform comprises a waste recycling bin disposed at the periphery of the second rotation table 60. The suction device 63 of the second rotation table 60 is adapted to directly place the detected defective chips into the waste recycling bin.

As shown in FIGS. 1 and 2, the chip sorting and packaging platform comprises a support frame 100, 200. The supply module, the sorting module and the packaging module are installed in the support frame 100, 200. The support frame 100, 200 includes a base frame 100 and a top frame 200. The base frame 100 has a mount base 110 onto which the supply module, the sorting module and the packaging module are mounted.

As shown in FIGS. 1 and 2, the chip sorting and packaging platform comprises an electronic control cabinet 90 mounted in the top frame 200. The electronic control cabinet 90 has a human-machine interaction interface 91 and a plurality of switch buttons 92.

The sorting and packaging of the chips is automatically achieved by the chip sorting and packaging platform described above, which greatly improves efficiency of sorting and packaging of the chips. In addition, it is also possible to improve accuracy and reliability of sorting the chips by using the disclosed chip sorting and packaging platform.

What is claimed is:

1. A chip sorting and packaging platform, comprising:
a supply module adapted to feed a plurality of chips;
a sorting module configured to pick up the chips fed by the supply module and to determine whether each of the chips is qualified; and
a packaging module configured to package qualified chips of the chips sorted by the sorting module.

2. The chip sorting and packaging platform of claim 1, wherein the sorting module includes:
a first rotation table;
a pickup device adapted to pick up the chips fed by the supply module and to mount the chips on the first rotation table; and
a first vision detector adapted to detect whether each chip mounted on the first rotation table has a defect.

3. The chip sorting and packaging platform of claim 2, wherein the sorting module includes a resistance detector adapted to detect a resistance of each chip mounted on the first rotation table.

4. The chip sorting and packaging platform of claim 3, wherein the first rotation table has a plurality of clamps adapted to secure the chips and distributed on the first rotation table around a rotation axis thereof at a predetermined interval.

5. The chip sorting and packaging platform of claim 4, wherein the pickup device includes a rotation disc and a plurality of suction nozzles distributed around the rotation disc at a predetermined interval, the suction nozzles adapted to suction to the chips from the supply module and adapted to mount the chips on the clamps of the first rotation table.

6. The chip sorting and packaging platform of claim 5, wherein the first visual detector includes a first camera and a second camera located above the first rotation table and spaced apart from each other, the first camera and the second camera are adapted to detect different defects of a top portion of each chip mounted on the first rotation table.

7. The chip sorting and packaging platform of claim 6, wherein the first camera is adapted to detect a scratch and/or a dirt on the top portion of the chip mounted on the first rotation table and the second camera is adapted to detect a solder joint defect on the top portion of the chip mounted on the first rotation table.

8. The chip sorting and packaging platform of claim 7, wherein the sorting module includes:
a second rotation table having a plurality of suction devices on the periphery thereof at a predetermined interval, the suction devices configured to suction to the chips at the first rotation table, the chips having been detected by the first vision detector and the resistance detector; and
a second vision detector adapted to detect a size of each chip suctioned to the suction devices on the second rotation table.

9. The chip sorting and packaging platform of claim 8, wherein the second visual detector includes a third camera and a fourth camera located around the second rotation table and spaced apart from each other, the third camera and the fourth camera are adapted to detect sizes of different sides of each chip suctioned by the suction devices on the second rotation table.

10. The chip sorting and packaging platform of claim 9, wherein an optical axis of the third camera and an optical axis of the fourth camera each extend in a radial direction of the second rotation table.

11. The chip sorting and packaging platform of claim 10, wherein a first side of each chip faces outwards in the radial direction when the chip is suctioned by one of the suction devices and the third camera detects a size of the first side of the chip.

12. The chip sorting and packaging platform of claim 11, wherein the sorting module includes a rotation mechanism adapted to rotate an orientation of the chip so a second side of the chip faces outwards in the radial direction and a size of the second side of the chip is detected by the fourth camera after the chip has been detected by the third camera.

13. The chip sorting and packaging platform of claim 12, wherein the packaging module includes:
a first pulley adapted to supply a first packaging belt having a plurality of recesses into which the qualified chips of the chips which have been detected by the sorting module are received;
a second pulley adapted to supply a second packaging belt for encapsulating the qualified chips in the recesses of the first packaging belt; and
a third pulley adapted to recycle the first packaging belt and the second packaging belt packaged with the qualified chips.

14. The chip sorting and packaging platform of claim 13, wherein the packaging module is disposed at the periphery of the second rotation table.

15. The chip sorting and packaging platform of claim 14, wherein each of the suction devices is adapted to directly place the qualified chips into the recesses of the first packaging belt.

16. The chip sorting and packaging platform of claim 15, further comprising a waste recycling bin disposed at the periphery of the second rotation table, each of the suction devices is adapted to directly place the chips having a defect which have been detected by the sorting module into the waste recycling bin.

17. The chip sorting and packaging platform of claim 16, wherein the supply module includes a centrifugal rotary conveyor and a vibratory linear conveyor, the centrifugal rotary conveyor is configured to centrifugally throw the chips placed therein onto the vibratory linear conveyor and the vibratory linear conveyor is configured to convey the chips thereon onto the sorting module in a vibrating manner.

18. The chip sorting and packaging platform of claim 17, further comprising a support frame into which the supply module, the sorting module, and the packaging module are installed.

19. The chip sorting and packaging platform of claim 18, wherein the support frame includes a base frame having a mount base onto which the supply module, the sorting module, and the packaging module are mounted and a top frame.

20. The chip sorting and packaging platform of claim 19, further comprising an electronic control cabinet mounted in the top frame and having a human-machine interaction interface and a plurality of switch buttons.
